(19) United States
(12) Patent Application Publication
(10) Pub. No.: US 2025/0172915 A1
(43) Pub. Date: May 29, 2025

(54) METHOD FOR ADAPTING A MACHINE LEARNING MODEL TO A CHANGED CONTROL SITUATION

(71) Applicant: Robert Bosch GmbH, Stuttgart (DE)

(72) Inventors: Alexander Qualmann, Schoenaich (DE); Anh Vien Ngo, Nehren (DE); Konradin Boersig, Tuttlingen (DE); Markus Spies, Karlsruhe (DE); Miroslav Gabriel, Muenchen (DE); Philipp Christian Schillinger, Renningen (DE)

(21) Appl. No.: 18/954,682

(22) Filed: Nov. 21, 2024

(30) Foreign Application Priority Data
Nov. 29, 2023 (DE) 10 2023 211 940.4

(51) Int. Cl. G05B 13/02

(52) U.S. Cl. CPC G05B 13/028

(57) ABSTRACT

A method for adapting a machine learning model to a changed control situation. The method includes detecting sensor data elements in the changed control situation; for each ascertained sensor data element generating multiple augmentations of the sensor data element; generating, for each augmentation, a respective output by means of a first instance of the machine learning model; ascertaining a target output for the sensor data element by combining the generated outputs; and ascertaining a loss between an output of a second instance for the sensor data element and the ascertained target output; and adapting the second instance of the machine learning model in order to reduce a total loss, which contains the ascertained losses.

### CROSS REFERENCE

The present application claims the benefit under 35 U.S.C. § 119 of German Patent Application No. DE 10 2023 211 940.4 filed on Nov. 29, 2023, which is expressly incorporated herein by reference in its entirety.

### FIELD

The present application relates to methods for adapting a machine learning model to a changed control situation.

### BACKGROUND INFORMATION

Picking up (i.e., gripping) an object is an important problem in robotics. Newer approaches utilize machine learning in order to make model-free gripping possible or a variety of unseen objects. In real-world applications, for example when removing objects from a container, the performance capability of these approaches, i.e., of a correspondingly trained machine learning model, typically depends on the conditions in the particular control situation and any change of the camera, the objects or the environment (in comparison to the situation for which the machine learning model has been trained) may adversely affect the gripping performance capability. In order to achieve reliable control (i.e., high gripping performance capability) even in changed conditions, the machine learning model can be post-trained with corresponding training data by means of supervised learning so that it is adapted to the particular situation. However, this requires a great deal of effort since additional training data (e.g., images) with associated annotations (i.e., “labels”) must be generated.

Approaches that make it possible to adapt a machine learning model with little effort to a changed control situation are therefore desirable.

According to various example embodiments of the present invention, a method for adapting a machine learning model to a changed control situation (in comparison to the control situation for which it has been trained) is provided, comprising:
detecting sensor data elements in the changed control situation;
for each ascertained sensor data element:
   generating multiple augmentations of the sensor data element;
   generating, for each augmentation, a respective output by means of a first instance of the machine learning model;
   ascertaining a target output for the sensor data element by combining the generated outputs; and
   ascertaining a loss between an output of a second instance for the sensor data element and the
ascertained target output; and
   adapting the second instance of the machine learning model in order to reduce a total loss, which contains the ascertained losses.

The method according to the present invention described above makes a self-monitored test time adaptation possible, i.e., an adaptation of a machine learning model to conditions in the inference that have changed in comparison to the training, for example in order to improve the performance capability of a neural grip prediction network in the case of changes of the camera providing input images for the grip prediction network (e.g., when using a new camera type for input image capture or when changing the installation situation), without the need for supervised training of the machine learning model with an annotated training data set.

Various exemplary embodiments of the present invention are specified below.

Exemplary embodiment 1 is a method for adapting a machine learning model to a changed control situation, as described above.

Exemplary embodiment 2 is a method according to exemplary embodiment 1, comprising adapting the first instance of the machine learning model toward the adapted second instance of the machine learning model.

The first instance (also referred to as a teacher model or, in particular, as a teacher network in the examples below) can thus follow the second instance (also referred to as a student model or, in particular, as a student network in the examples below), for example at a certain interval of batches, as described in the following examples.

Exemplary embodiment 3 is a method according to exemplary embodiment 1, comprising, for each batch of a sequence of batches:
detecting respective sensor data elements in the changed control situation;
for each sensor data item ascertained for the batch:
   generating multiple augmentations of the sensor data element;
   generating, for each augmentation, a respective output by supplying the generated augmentation to a respective first instance of the machine learning model (for the batch);
   ascertaining a target output for the sensor data element by combining the generated outputs; and
   ascertaining a loss between an output of a respective second instance (for the batch) for the sensor data element and the ascertained target output; and
adapting the respective second instance of the machine learning model in order to reduce a total loss, which contains the ascertained losses, wherein, for each batch of the sequence, except for the last one, the respective adapted second instance of the machine learning model is used as the second instance of the machine learning model of the subsequent batch in the sequence.

The adaptation described in the above method may thus refer to a batch (i.e., the detected sensor data elements are those of one batch) and may accordingly be repeated for further batches, wherein the second instance is successively adapted over the course of the sequence so that the accuracy of the machine learning model is increased over time (e.g., in ongoing operation). As mentioned above, the first instance may follow the second instance:

Exemplary embodiment 4 is a method according to exemplary embodiment 3, comprising adapting the first instance of the machine learning model toward the second instance of the machine learning model after a specified number of batches.

The number of batches may also be one, i.e., the first instance may directly follow the second instance but, for example, in a weighted manner (see example below) so that the first instance nonetheless follows the second instance slowly. This ensures stability in the adaptation. For the first batch of the sequence, the first instance and the second instance may be set to the machine learning model to be adapted.

Exemplary embodiment 5 is a method according to one of exemplary embodiments 1 to 4, wherein the sensor data elements are image data elements.

Here, image data elements are understood as data elements in matrix form with one or more channels (i.e., one or more values per position in the matrix, i.e., per “pixels”). Such sensor data elements make it possible to effectively represent scenarios in which controlling is to take place. For example, the machine learning model is (or contains) a convolutional neural network.

Exemplary embodiment 6 is a method according to exemplary embodiment 5, wherein the change in the control situation to which the adaptation is made is a change of a camera and/or the change of one or more conditions of an image capture by means of a camera (114) with which the image data elements are captured.

By means of the above method, it is thus possible to adapt a machine learning model with low training effort and without explicit annotations of sensor data elements (but with the generated pseudo-labels, i.e., target outputs) to changes of the camera or image capture conditions (such as changes in lighting, color shifts, etc.).

Exemplary embodiment 7 is a method according to exemplary embodiment 5 or 6, wherein the image data elements have multiple channels, and generating the respective output for each augmentation and generating the output of the second instance for each sensor data element comprise trainable scaling of the respective values of the channels, wherein the scaling is also adapted in order to reduce the total loss.

Exemplary embodiment 8 is a method for controlling a robotic device, comprising:
adapting a machine learning model to a control situation in which the robotic device is to be controlled, by means of the method according to one of exemplary embodiments 1 to 7;
detecting one or more further sensor data elements in the control situation;
processing the one or more further sensor data elements by means of the adapted second instance of the machine learning model or a first instance of the machine learning model that has been adapted toward the adapted second instance; and
generating a control signal for the robotic device according to a result of the processing.

Exemplary embodiment 9 is a data processing unit (in particular, a control unit for a robotic device) configured to perform the method according to one of exemplary embodiments 1 to 8.

Exemplary embodiment 10 is a computer program comprising commands that, when executed by a processor, cause the processor to perform a method according to one of exemplary embodiments 1 to 8.

Exemplary embodiment 11 is a computer-readable medium which stores commands that, when executed by a processor, cause the processor to perform a method according to one of exemplary embodiments 1 to 8.

In the figures, similar reference signs generally refer to the same parts throughout the different views. The figures are not necessarily to scale, wherein emphasis is instead generally placed on representing the principles of the present invention.

In the following description, various aspects are described with reference to the figures.

### BRIEF DESCRIPTION OF THE DRAWINGS

FIG. 1 shows a robot according to an example embodiment of the present invention.

FIG. 2 illustrates a test time adaptation method for a machine learning model according to one example embodiment of the present invention.

FIG. 3 shows a flowchart illustrating a method for adapting a machine learning model to a changed control situation according to one example embodiment of the present invention.

### DETAILED DESCRIPTION OF EXAMPLE EMBODIMENTS

The following detailed description relates to the figures, which, for clarification, show specific details and aspects of this disclosure in which the present invention can be implemented. Other aspects may be used, and structural, logical, and electrical changes may be performed without departing from the scope of protection of the invention. The various aspects of this disclosure are not necessarily mutually exclusive since some aspects of this disclosure can be combined with one or more other aspects of this disclosure to form new aspects.

Various examples are described in more detail below.

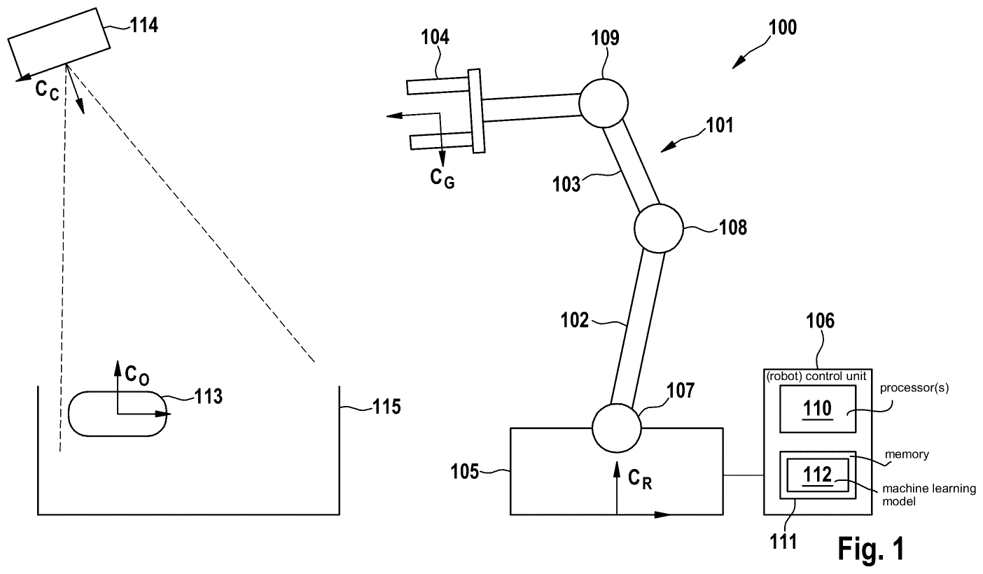

FIG. 1 shows a robot 100.

The robot 100 includes a robot arm 101, for example an industrial robot arm for handling or assembling a workpiece (or one or more other objects). The robotic arm 101 includes movable arm elements 102, 103, 104 and a base (or support) 105, which supports the arm elements 102, 103, 104. The term “movable arm elements” refers to the movable components of the robotic arm 101, the actuation of which makes physical interaction with the environment possible in order, for example, to perform a task. For control, the robot 100 includes a (robot) control unit 106 designed to implement the interaction with the environment according to a control program. The last arm element 104 (which is farthest away from the support 105) of the arm elements 102, 103, 104 is also referred to as the end effector 104 and may include one or more tools, such as a welding torch, a gripping tool, a painting device, or the like.

The other arm elements 102, 103 (located closer to the support 105) may form a positioning device so that the robot arm 101 with the end effector 104 at its end is provided together with the end effector 104. The robot arm 101 is a mechanical arm (possibly with a tool at its end).

The robot arm 101 may include joint elements 107, 108, 109, which connect the arm elements 102, 103, 104 to one another and to the support 105. A joint element 107, 108, 109 may have one or more joints, which may each provide a rotatable movement (i.e., rotational movement) and/or translational movement (i.e., displacement) for associated arm elements relative to one another. The movement of the arm elements 102, 103, 104 can be initiated by means of actuators controlled by the control unit 106.

The term “actuator” can be understood to mean a component that is configured to effect a mechanism or process in response to being driven. The actuator can implement instructions (the so-called activation) created by the control unit 106 into mechanical movements. The actuator, e.g., an electromechanical converter, may be designed to convert electrical energy into mechanical energy in response to being activated.

The term “control unit” can be understood to mean any type of logic-implementing entity (including one or more computers), which may, for example, include a circuit and/or a processor, which are capable of executing software, firmware, or a combination thereof stored in a storage medium, and which can issue instructions, for example to an actuator in the present example. For example, the control unit may be configured by program code (e.g., software) to control the operation of a system, of a robot in the present example.

In the present example, the control unit 106 includes one or more processors 110 and a memory 111 that stores code and data on the basis of which the processor 110 controls the robot arm 101. According to various embodiments, the control unit 106 controls the robot arm 101 on the basis of a machine learning model 112 stored in the memory 111.

According to various embodiments, the machine learning model 112 is designed and trained to make it possible for the robot 100 to recognize manipulation poses of one or more objects 113 where the robot 100 can pick up (or otherwise interact with, e.g., paint) the object(s) 113.

The robot 100 may, for example, be equipped with one or more cameras 114 that allow it to record images of its working space. The camera 114 is, for example, fastened to the robot arm 101 so that the robot can take images of the object 113 from various perspectives by moving its robot arm 101. However, the camera 114 may also be fixedly mounted in a robot cell, as shown in FIG. 1, in order to capture the objects to be gripped.

According to various embodiments, the machine learning model 112 is a neural network, and the control unit 106 supplies input data to the neural network on the basis of the one or more digital images (depth images with optional color images or a point cloud with optional color images or further pixel-wise information such as information about the surface normal) of an object 113, and the neural network (in particular a neuronal “grip prediction network” in this example) ascertains, for example, for each of multiple locations (on the surface) of the object, a quality, which indicates how well the object can be gripped at the respective location. Instead of continuous values (i.e., instead of a regression), the machine learning model 112 (e.g., neural network) may also classify, e.g., into “good location for gripping” and “bad location for gripping.” It may also output further continuous values, e.g., orientations for each location for the end effector 104 (assumed as a gripper below by way of example) and then, for each orientation, a quality (manipulation quality or, below, grip quality), which indicates how well the object can be manipulated (gripped as an example below) with the orientation at the location.

The case may occur that the machine learning model 112 has been trained for a particular (control) situation (i.e., under certain conditions) but is then to be used in a different situation (referred to as “test time,” which however also includes the inference during use). For example, the camera 114 may be replaced so that the manner in which the object 113 is represented in the input data of the machine learning model 112 changes (e.g., lens properties, noise behavior, etc. change). In order to compensate for this, a so-called test time adaptation can be performed. Further examples in this respect include compensation for the change in object properties or ambient conditions (e.g., light conditions), the composition and number of the particular objects, or the positioning of the camera relative to the particular objects. Generally, a test time adaptation may always be applied if a domain shift (or domain gap) occurs between training data and test time data.

According to various embodiments, a test time adaptation is provided, which aims at adapting a pre-trained ML (machine learning) model for the inference without the need for annotated training data (with ground truth, i.e., typically labels). For example, this test time adaptation is performed to adapt a neural grip prediction network to a camera change (e.g., as a result of replacing the camera 114). According to various embodiments, a test time adaptation is thus, for example, used to make it possible to adapt a neural network for pixel-wise grip prediction to a camera change (or “domain shift”) between training and test time without monitored (re-)training and thus without additional annotation effort.

According to various embodiments, a mean teacher concept is specifically used for a self-monitored test time adaptation of a machine learning model (wherein it is possible to integrate input image channel scaling). The “mean teacher” (i.e., a machine teacher model) provides pseudo-labels (or soft-pseudo-labels), which are used, for example, to adapt network weights and batch normalization statistics of a convolutional neural networks (CNN) used as a grip prediction network. This approach may be used as a real-time adaptation or during an initial adaptation phase to update the network weights and batch normalization statistics according to new input images, for example from a new camera type. The approach is not limited to a particular CNN network architecture.

According to various embodiments, a mean teacher framework with test time augmentation and image channel scaling is thus used to make robust network predictions possible for new input images with unknown domain shifts, e.g., from new unknown camera types, even at the runtime of the model. This results in the following:
(1) The grip prediction network, which has been trained on image data from one or more known cameras, may be adapted to images with domain shifts (e.g., images from unknown camera types or unknown camera mounting positions or unknown properties of the gripped object, such as surface reflections, color shifts, etc.) by means of this approach of self-monitored post-training without the need for re-training on labeled image data.
(2) The approach may be used in an offline or online setting either to adapt to a new domain shift during an initial adaptation phase with a fixed set of input images or to adapt continuously during the runtime of the application.
(3) The integration of the test time augmentation into the mean teacher predictions (i.e., the pseudo-labels) makes it possible to generate robust pseudo-labels by exploiting the phenomenon that CNNs are not completely invariant to symmetries in the data distribution of the new input data, even after the training with augmented training samples.
(4) The integration of learnable channel scaling into the test time adaptation method makes it possible to automatically adapt weight factors for each image input channel (e.g., RGB, depth, etc.). This results in more robust predictions in the case of unbalanced domain shifts between the input channels, for example if a new type of RGB-D camera provides a similar quality of the RGB images but less accurate depth images.

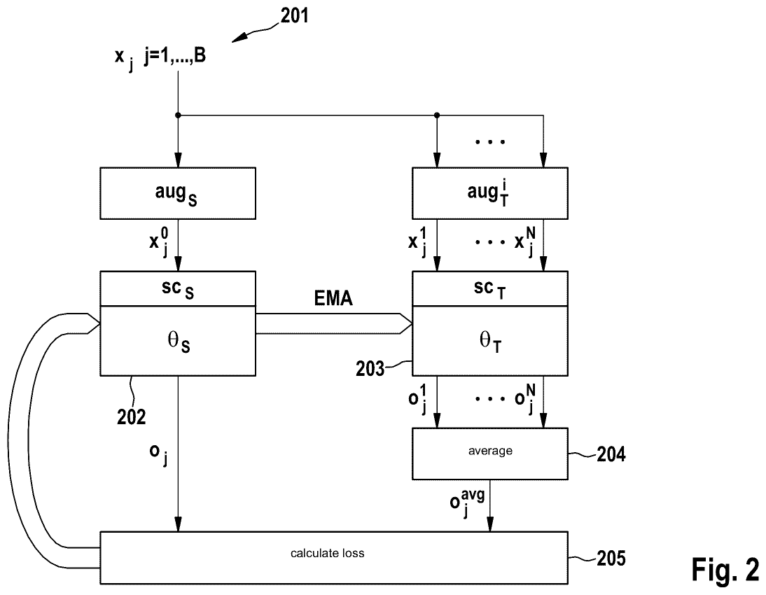

FIG. 2 illustrates a test time adaptation method for a machine learning model according to one embodiment.

The test time adaptation method may, for example, be applied to a neural network, e.g., to various CNN network architectures. For example, the machine learning model maps an input image (e.g., RGB, or RGB-D (RGB plus depth information)) to an output of the same resolution as the input image. As mentioned above, the output may be a classification (e.g., distinguishing between good or bad grip positions in the input image, or a classification of objects in the case of autonomous driving) or continuous values (e.g., the probability of a stable grip). Two versions of the machine learning model are used in the test time adaptation method: a “student network” 202 and a “teacher network” 203. Both are initialized to the machine learning model to be adapted (i.e., initially, both match the machine learning model to be adapted). The weights of the machine learning model to be adapted (and thus the initial weights of the student network 202 and of the teacher network 203) are denoted by θ_{S}_{ₚᵣₑ} prior to its adaptation.

The input of the test time adaptation method includes a batch 201 of B input images xⱼ∈ [symbol] ^{H×W×3}, j=1, . . . , B, for example captured by a camera other than the camera(s) used to capture the images for training the machine learning model 201 to be adapted (hereinafter assumed to be a neural network).

For the teacher network 203, for each of the input images N, different augmented input images xⱼⁱ=aug_{T}ⁱ(xⱼ)∈ [symbol] ^{H×W×3} are generated from the input images by using N different augmentation transformations. Here, the augmentation transformations aug_{T}ⁱ, i=1, . . . , N may apply different image augmentation techniques (e.g., resizing, mirroring, adding noise, etc.) separately for each image channel, depending on the type of image channel (e.g., RGB, depth).

For each augmented input image (i.e., each augmentation), the different image channels are then scaled with a learnable vector γ by a function sc (for “scale”) so that the test time adaptation method can adapt the scaling of each input channel (i.e., image channels in the present example) for the test time:

$${sc}_{T} ( {x}_{j}^{, i} , {γ}_{T} ) = {x}_{j}^{, i} \cdot {γ}_{T}$$

where

$$γ \text{?} = ( \begin{matrix}γ \text{?} \\ ⋯ \\ {γ}_{{T}_{C}}\end{matrix} )$$

$$\text{?} \text{indicates text missing or illegible when filed}$$

where C is the number of the different input channels (e.g., RGB, depth, etc.).

Different domain shifts between the input channels can thereby be taken into account, for example in the case of a new camera with a different domain shift between the RGB channel and the depth channel in comparison to the camera with which the images were captured for the training of the network.

After their scaling, the augmented individual images are guided through the teacher network 203, resulting in N different teacher outputs (output images in the present exemplary embodiment):

$${o}_{j}^{i} = {f}_{T} ( {x}_{j}^{i} ; {θ}_{T} ) ∈ {ℝ}^{H \times W}$$

where θ_{T} are the weights of the teacher network 203, which are initialized with the weights θ_{S}_{ₚᵣₑ} as mentioned above.

Subsequently, the different outputs are merged into a single output oⱼ^{avg}=avg(oⱼ¹, . . . , oⱼ^{N})∈ [symbol] ^{H×W} by averaging 204.

where avg represents various possible averaging techniques for calculating the average at each pixel coordinate (n,m), for example the arithmetic mean:

$${[ {o}_{j}^{avg} ]}_{n , m} = \frac{1}{N} {\sum }_{i = 1}^{N} {[ {o}_{j}^{i} ]}_{n , m}$$

or the geometric mean:

$${[ {o}_{j}^{avg} ]}_{n , m} = {( {\prod }_{i = 1}^{N} {[ {o}_{j}^{i} ]}_{n , m} )}^{\frac{1}{N}}$$

However, weighted averaging may also be performed (e.g., the augmentations are weighted differently depending on the augmentation transformation used (e.g., type and/or strength of the transformation)).

In order to make it possible to merge the output images, an inverted augmentation transformation may be applied to each output image (in a manner corresponding to the augmentation transformation with which the augmented input image processed by the teacher network 203 to form the output image was generated).

The underlying idea of the augmentation mean oⱼ^{avg} (used as a pseudo-label for the training of the machine learning model 202) can be seen in achieving high quality of the pseudo-labels by merging the output images calculated with the augmented versions of the same input images. Especially in convolution networks, this “ensembling” exploits the phenomenon that convolution networks (CNNs) are not entirely invariant to augmentations, even after the training with augmented training samples.

In the case of the student network 202, generating an augmentation xⱼ⁰=aug_{S}(xⱼ)∈ [symbol] ^{H×W×3} of the input image is optional and may be taken from one of the augmentations of the teacher network 203.

It is also possible to use multiple augmentations of the student network 202 and to average the output images of the student network 203 as described for the teacher network 203, i.e., xⱼⁱ=aug_{T}ⁱ(xⱼ)∈ [symbol] ^{H×W×3}. The different image channels of the student network 202 are then scaled by a learnable vector γS so that the test adaptation method can adapt the scaling of each input channel for the test time:

$${sc}_{s} ( {x}_{j}^{0} , γ s ) = {x}_{j}^{0} \cdot {γ}_{s}$$

with

$${γ}_{S} = ( \begin{matrix}{γ}_{S} \text{?} \\ ⋯ \\ {γ}_{{S}_{C}}\end{matrix} )$$

$$\text{?} \text{indicates text missing or illegible when filed}$$

and C as above.

The augmented input image scaled in this way is then guided through the student network 202 with the network weights OS, which have been initialized with the pre-trained source model weights θ_{S}_{ₚᵣₑ} as discussed above. If the input image xⱼ⁰ was generated by means of an augmentation transformation, a corresponding inverted augmentation transformation is applied to the oⱼ prior to calculating the loss 205.

Finally, the outputs of the teacher path oⱼ^{avg} and the outputs of the student path oⱼ are used to calculate the (total) loss 205 for the batch. The loss 205 is a consistency loss and given, for example, by:

$$ℒ = \frac{1}{B \cdot H \cdot W} {\sum }^{B} \text{?} {\sum }^{H} \text{?} {\sum }^{W} \text{?} l ( {[ {o}_{j} ]}_{n , m} , {[ {o}_{j}^{avg} ]}_{n , m} )$$

$$\text{?} \text{indicates text missing or illegible when filed}$$

where B is the number of input images of the batch, H is the height, W is the width of the output images, and l is the loss per pixel between the j-th output of the student path and of the teacher path. The value

$${\sum }^{H} \text{?} {\sum }^{W} \text{?} l ( {[ {o}_{j} ]}_{n , m} , {[ {o}_{j}^{avg} ]}_{n , m} )$$

$$\text{?} \text{indicates text missing or illegible when filed}$$

can be seen as a loss (or “individual loss”) for the j-th input image (generally sensor data element).

The pixel-wise loss l may be represented by various loss functions, e.g., 11 loss, 12 loss, or cross-entropy loss (depending on the type of pixel value).

The student network 202 is updated by back propagation of the loss 202. This loss enforces consistency between the student network output and the pseudo-label.

According to one embodiment, the teacher network 203 is updated with an exponential moving average EMA: At each training step of the teacher network (index t, wherein a training step of the teacher network is, for example, performed after a certain number of batches), the weights of the student model 202 are used to update the teacher network 203, resulting in a continuously trained and time-averaged teacher network 203. Since it can be assumed that the predictions of the (mean) teacher network 203 are more accurate than the outputs of the student network 202, they can be used as pseudo-labels for the self-monitored training of the student network 202 (as described above). For example, the weights of the teacher model 203 are updated as follows:

$${θ}_{T}^{( t )} = α \cdot {θ}_{T}^{( t - 1 )} + ( 1 - α ) \cdot {θ}_{S}^{( t )}$$

where 0<α<1 defines the mixing ratio of student weights and teacher weights and brings about smoothing. In this case, a higher value results in a slower moving average, which is, for example, useful when adapting over a large number of adaptation steps.

In addition, the batch normalization layers of the student network and of the teacher network are in training mode during the test time adaptation and are re-estimated according to the test time data.

Described below are various approaches for using the test time adaptation method, described with reference to FIG. 2, for adapting a grip prediction network (e.g., to a new camera).

There are three main variants of using the results of the test time adaptation method for the grip prediction in a new control situation:
1. Use of a grip prediction network with the weights and batch normalization statistics of the student network
2. Use of a grip prediction network with the weights and batch normalization statistics of the teacher network
3. Use of a grip prediction network with the weights and batch normalization statistics of the teacher network and augmentation averaging (as described for the teacher network) during the inference. The batch normalization statistics are the parameters for the batch normalization (BN) layers of the respective neural network. Strictly speaking, they are not trained weights but are calculated for the training data during the training. These BN statistics are specific to the training data. In the case of a domain shift in comparison to the test time data, the BN statistics (in addition to the weights) can therefore also be adapted (e.g., analogously to the weights as described above).

In case 1, the student network 202 should result in more robust predictions after the self-monitored training than the original machine learning model. In case 2, the network weights are calculated by time-averaging, which could lead to even more robust results. Finally, in case 3, the prediction result is ascertained by multiple augmentations and average formation, which can reduce the errors occurring in a single forward calculation. However, this is associated with computational costs for multiple forward calculations during the grip prediction.

In addition, there are two main approaches for implementing the proposed test time adaptation method in a grip prediction application:
1. Adaptation with a fixed set of input images prior to application to additional input images in an adaptation phase
2. Online test time adaptation as a continuous process during the grip prediction (i.e., in general, the inference by means of the machine learning model).

In case 1, the test time adaptation method generates adapted network weights and BN statistics for a fixed amount of input images during the adaptation phase. After the adaptation phase, the network weights and BN statistics are defined and used for new images.

In case 2, the test time adaptation method is integrated into a pipeline for the grip prediction, and the network weights and BN statistics are continuously updated for each new input image. In this case, the adaptation may take into account new domain shifts over time. However, effects such as error accumulation and catastrophic forgetting should be taken into account.

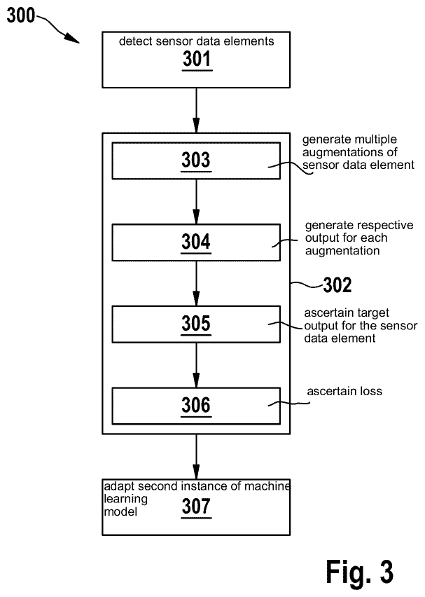

In summary, a method is provided according to various embodiments, as shown in FIG. 3.

FIG. 3 shows a flowchart 300 illustrating a method for adapting a machine learning model (in a self-monitored manner) to a changed control situation (in comparison to the control situation for which it has been trained), according to one embodiment.

In 301, sensor data elements are detected in the changed control situation.

In 302, for each ascertained sensor data element:
in 303, multiple augmentations of the sensor data element are generated (i.e., changed (transformed) versions, e.g., by resizing, mirroring, adding noise, shifting, rotating, changing color, etc.)
in 304, for each augmentation, a respective output is generated by means of a first instance of the machine learning model
in 305, a target output for the sensor data element is ascertained by combining (e.g., averaging) the generated outputs
in 306, a loss between an output of a second instance for the sensor data element (generated by processing the sensor data element or augmenting it by means of the second instance) and the ascertained target output is ascertained (ascertaining the loss may include a back augmentation in order to make a comparison between the outputs possible).

In 307, the second instance of the machine learning model is adapted in order to reduce a total loss, which contains the ascertained losses (e.g., by back-propagating the loss and adapting the parameters (e.g., weights or batch normalization statistics) of the machine learning model in the direction of decrease of the total loss).

The approach of FIG. 3 makes it possible to adapt a pre-trained ML model (e.g., grip prediction model) such that it takes into account changes (or “shifts”) in the input image domain (e.g., due to new camera types) without the need for re-training and access to marked training data. The method may be used in connection with gripping by means of robots, for example when removing objects from containers, in order to make robust predictive performance possible even if new cameras or new camera mounting positions are used or if object properties such as surface reflections change.

The result of the method of FIG. 3 are (for the example of a neural network as the machine learning model) adapted network weights (and thus their statistical properties) that can be used directly by the grip prediction network for predicting grips on images with domain shifts.

The method of FIG. 3 can be performed by one or more computers comprising one or more data processing units. The term “data processing unit” can be understood to mean any type of entity that makes the processing of data or signals possible. The data or signals may, for example, be processed according to at least one (i.e., one or more than one) specific function performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination thereof. Any other way of implementing the corresponding functions described in more detail here can also be understood as a data processing unit or logic circuitry. One or more of the method steps described in detail here can be performed (e.g., implemented) by a data processing unit by means of one or more specific functions performed by the data processing unit.

According to various embodiments, the method is thus, in particular, computer-implemented.

After the training (i.e., the test time adaptation), the machine learning model may be applied to sensor data ascertained by at least one sensor. For example, after the training, the machine learning model is used to generate a control signal for a robotic device by supplying the machine learning model with sensor data relating to the robotic device and/or its environment. The term “robotic device” can be understood as relating to any technical system (with a mechanical part whose movement is controlled), such as a computer-controlled machine, a vehicle, a household appliance, an electric tool, a manufacturing machine, a personal assistant, or an access control system.

In addition to images with gray levels, color channels or a depth channel, various embodiments may also receive and use sensor data from various other sensors, such as video, radar, LiDAR, ultrasound, motion, thermal imaging, etc.

What is claimed is:

1. A method for adapting a machine learning model to a changed control situation, comprising:
detecting sensor data elements in the changed control situation;
for each sensor data element of the detected sensor data elements:
generating multiple augmentations of the sensor data element,
generating, for each augmentation, a respective output by means of a first instance of the machine learning model,
ascertaining a target output for the sensor data element by combining the generated outputs,
ascertaining a loss between an output of a second instance for the sensor data element and the ascertained target output; and
adapting a second instance of the machine learning model in order to reduce a total loss, which contains the ascertained losses.

2. The method according to claim 1, further comprising adapting the first instance of the machine learning model toward the adapted second instance of the machine learning model.

3. The method according to claim 1, comprising:
for each batch of a sequence of batches:
detecting respective sensor data elements in the changed control situation;
for each respective sensor data element of the respective sensor data elements ascertained for the batch:
generating multiple augmentations of the respective sensor data element,
generating, for each augmentation, a respective output by supplying the generated augmentation to a respective first instance of the machine learning model,
ascertaining a target output for the respective sensor data element by combining the generated outputs, and
ascertaining a loss between an output of a respective second instance for the respective sensor data element and the ascertained target output, and
adapting the respective second instance of the machine learning model in order to reduce a total loss, which contains the ascertained losses;
wherein, for each batch of the sequence, except for a last one, the respective adapted second instance of the machine learning model is used as the second instance of the machine learning model of the subsequent batch in the sequence.

4. The method according to claim 3, further comprising adapting, after a specified number of batches, the first instance of the machine learning model toward the second instance of the machine learning model.

5. The method according to claim 1, wherein the sensor data elements are image data elements.

6. The method according to claim 5, wherein the change in the control situation to which the adaptation is made is a change of a camera and/or a change of one or more conditions of an image capture using a camera with which the image data elements are captured.

7. The method according to claim 3, wherein the image data elements have multiple channels and generating the respective output for each augmentation and generating the output of the second instance for each sensor data element includes trainable scaling of the respective values of the channels, wherein the scaling is also adapted in order to reduce the total loss.

8. A method for controlling a robotic device, comprising:
adapting a machine learning model to a control situation in which the robotic device is to be controlled, the adapting including:
detecting sensor data elements in the changed control situation;
for each sensor data element of the detected sensor data elements:
generating multiple augmentations of the sensor data element,
generating, for each augmentation, a respective output by means of a first instance of the machine learning model,
ascertaining a target output for the sensor data element by combining the generated outputs, and
ascertaining a loss between an output of a second instance for the sensor data element and the ascertained target output;
adapting a second instance of the machine learning model in order to reduce a total loss, which contains the ascertained losses;
adapting the first instance of the machine learning model toward the adapted second instance of the machine learning model;
detecting one or more further sensor data elements in the control situation;
processing the one or more further sensor data elements using the adapted second instance of the machine learning model or a first instance of the machine learning model that has been adapted toward the adapted second instance; and
generating a control signal for the robotic device according to a result of the processing.

9. A data processing unit configured to controlling a robotic device, the data processing unit configured to perform the following steps:
adapting a machine learning model to a control situation in which the robotic device is to be controlled, the adapting including:
detecting sensor data elements in the changed control situation;
for each sensor data element of the detected sensor data elements:
generating multiple augmentations of the sensor data element,
generating, for each augmentation, a respective output by means of a first instance of the machine learning model,
ascertaining a target output for the sensor data element by combining the generated outputs, and
ascertaining a loss between an output of a second instance for the sensor data element and the ascertained target output;
adapting a second instance of the machine learning model in order to reduce a total loss, which contains the ascertained losses;
adapting the first instance of the machine learning model toward the adapted second instance of the machine learning model;
detecting one or more further sensor data elements in the control situation;
processing the one or more further sensor data elements using the adapted second instance of the machine learning model or a first instance of the machine learning model that has been adapted toward the adapted second instance; and
generating a control signal for the robotic device according to a result of the processing.

10. A non-transitory computer-readable medium on which are stored commands for controlling a robotic device, the commands, when executed by a processor, causing the processor to perform the following steps:
adapting a machine learning model to a control situation in which the robotic device is to be controlled, the adapting including:
detecting sensor data elements in the changed control situation;
for each sensor data element of the detected sensor data elements:
generating multiple augmentations of the sensor data element,
generating, for each augmentation, a respective output by means of a first instance of the machine learning model,
ascertaining a target output for the sensor data element by combining the generated outputs, and
ascertaining a loss between an output of a second instance for the sensor data element and the ascertained target output;
adapting a second instance of the machine learning model in order to reduce a total loss, which contains the ascertained losses;
adapting the first instance of the machine learning model toward the adapted second instance of the machine learning model;
detecting one or more further sensor data elements in the control situation;
processing the one or more further sensor data elements using the adapted second instance of the machine learning model or a first instance of the machine learning model that has been adapted toward the adapted second instance; and
generating a control signal for the robotic device according to a result of the processing.
